(19) United States
(12) Patent Application Publication
(10) Pub. No.: US 2008/0221756 A1
(43) Pub. Date: Sep. 11, 2008

(54) Air suspension to control power hop

(76) Inventor: Mark R. Miskin, Alta, WY (US)

Correspondence Address: MORRISS OBRYANT COMPAGNI, P.C., 734 EAST 200 SOUTH, SALT LAKE CITY, UT, 84102, US

(21) Appl. No.: 11/713,926

(22) Filed: Mar. 5, 2007

(51) Int. Cl. B60G 17/018; B60G 23/00; B60G 9/04

(52) U.S. Cl. 701/37; 280/124.157

(57) ABSTRACT

Apparatus, systems and methods for controlling power-hop in a heavy vehicle, e.g., an earth-moving apparatus, such as an earth-moving scraper.

### TECHNICAL FIELD

The present invention relates generally to suspensions for heavy equipment, including land-leveling scrapers and apparatus for modifying the earth's surface by removing soil from the earth's surface at one location and moving the soil to a new location. More specifically, the present invention relates to an air suspension for heavy equipment, such as scrapers, to control an undesired phenomenon known as power hop.

### BACKGROUND

“Power Hop” is a problem associated with tractor and any other heavy vehicle to some degree or another. Power hop is a condition experienced when pulling a heavy load. During a hard pull, the engine-transmission-driveline will “climb up” the differential gear, raising the nose of the tractor. Eventually, the tires or tracks will slip and the nose drops down toward the ground surface. As the nose falls, there is an increase in traction again. The increase in traction causes the engine-transmission-driveline to climb up the differential gear again in a repeating cycle. These rhythmic actions compound, resulting in a significant loss of traction, operator discomfort and wear on the transmission and drive from the power spikes. The severity of power hop depends on a variety of factors including vehicle design, weight, balance, ground-traction conditions, tires, tracks, etc.

Various approaches have been taken in the past to control the power-hop phenomenon. A passive approach is disclosed in U.S. Pat. No. 6,260,873 to Bishel et al. Bishel et al. discloses an isolation hitch interposed between and attached to a drive vehicle and an object to be moved, e.g., a scraper, that attempts to dampen the effect of a power-hop. Another passive approach is disclosed in U.S. Patent Application Publication No. US2005/0269796 to Sawarynski et al. Sawarynski et al. discloses using a pair of half-leaf springs and snubber adapted for operative attachment at a rear end of a Hotchkiss-type leaf-spring suspension in an attempt to dampen the effects of power-hop.

Others have taken to active systems for controlling power-hop. For example, U.S. Pat. No. 5,474,147 to Yesel et al. attempts to solve the power-hop problem by adjusting power delivered to front drive in an all-wheel-drive tractor. U.S. Pat. No. 6,401,853 to Turski et al. attempts to solve power-hop by adjusting power from the engine. U.S. Pat. No. 6,589,135 to Miller attempts to solve power-hop by varying fuel to the engine based on vehicle acceleration sensing. However, none of the prior art solutions appear to actively adjust the suspension systems that are directly affected by the power-hop.

Thus, a method and system for controlling power-hop by actively adjusting an air suspension system would be an improvement in the art.

### SUMMARY

An embodiment of an air suspension system for controlling power-hop on a heavy vehicle is disclosed according to the present invention. The air suspension system may include an axle having opposite ends and air suspensions disposed along the axle, proximate the ends. The air suspension system may further include a computer for sensing a power-hop condition and selectively activating the air suspensions to counteract the sensed power-hop condition.

An embodiment of a method of counteracting power-hop is disclosed according to the present invention. The method may include sensing a power-hop condition and selectively adjusting an air suspension system to counteract the power-hop condition.

An embodiment of a system for sensing and controlling power-hop in an active air suspension system is disclosed according to the present invention. The system may include a plurality of sensors for measuring parameters relevant to a power-hop condition. The system may further include a computer in communication with the plurality of sensors and the active air suspension system, the computer configured to selectively activate the active air suspension system to minimize power-hop oscillations based on the measured parameters received from the plurality of sensors.

Additional features and advantages of the invention will be set forth in the description which follows, and in part will be apparent from the description, or may be learned by the practice of the present invention.

### DESCRIPTION OF THE DRAWINGS

It will be appreciated by those of ordinary skill in the art that the elements depicted in the various drawings are for exemplary purposes only. The nature of the present invention, including the best mode, as well as other embodiments of the present invention, may be more clearly understood by reference to the following detailed description of the invention, to the appended claims, and to the several drawings.

FIG. 1 is a block diagram of an embodiment of an air suspension system for controlling power-hop on a heavy vehicle according to the present invention.

FIG. 2 is a block diagram of a two-axle air suspension system for controlling power-hop according to the present invention.

FIG. 3 is a flow chart of an embodiment of a method of counteracting power-hop according to the present invention.

FIGS. 4A-B are images of exemplary conventional air suspension systems that provide the general structure for application of the systems according to the present invention.

### DETAILED DESCRIPTION

Embodiments of the air suspension system according to the present invention counter the bounce caused by power hop by using air suspensions on the tractor's axles. Embodiments of the present invention may employ sensors placed on the tractor that feed various types on information into an on-board computer. The computer may be configured to calculate parameters and timing of the rhythm associated with an anticipated power hop. In response to sensing the onset of a power hop, the computer may be configured to control pneumatic valves in an air suspension that would move the suspension in such a way as to eliminate or minimize the undesirable bounce, or disrupt its rhythm before the bounces grow in severity. Sensors may be configured to collect various inputs including but not limited to acceleration/deceleration, travel speed, pulling force, torque, and any other measurement that might be used to detect the onset of a power hop. Air suspensions are common on semi trucks and trailers are not new, but they are not used on farm tractors.

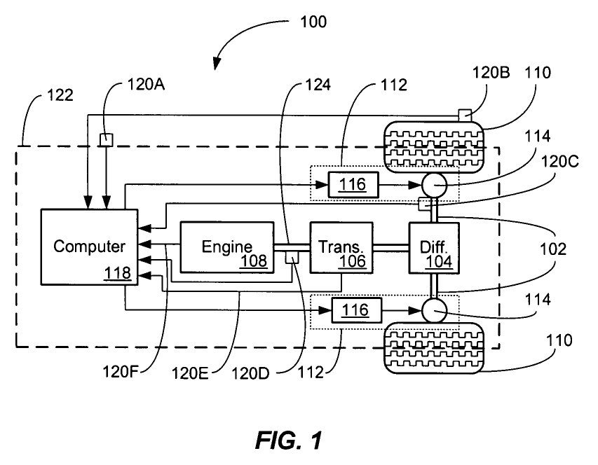

Referring to FIG. 1, a block diagram of an embodiment of an air suspension system 100 for controlling power-hop on a heavy vehicle is shown according to the present invention. System 100 may include an axle 102 having opposite ends. The opposite ends may be separated by a differential 104, driven by a transmission 106, which is driven in by an engine 108. The opposite ends of the axle 102 may include hubs (not shown) for mounting wheels 110 according to one embodiment of the present invention. The hubs may be in communication with tracks (not shown) according to another embodiment.

System 100 may further include air suspensions 112 (shown in small dotted line) disposed along the axle 102, proximate the ends. Axle 102 may be a front axle or a rear axle according to embodiments of the present invention. The air suspensions 112 may be of any known configuration that allows the addition of air to make the air suspension 112 stiffer in ride and the release of air to make the air suspension 112 softer in ride. According to embodiments of system 100, the air suspension 112 may further include air bladders 114 or pneumatic air cylinders 114 for containing pressurized air. According to another embodiment of system 100, the air suspension 112 may further include a pneumatic valve 116 within the air suspension 112 for adding or releasing air to the air bladders 114 or pneumatic air cylinders 114. According to still another embodiment of system 100, the air suspension 112 may further include a pneumatic valve 116 connected directly to the air bladders 114 or pneumatic air cylinders 114, as shown in FIG. 1. According to yet another embodiment of system 100, the air suspension 112 may further include a pneumatic valve 116 in communication with the air suspensions 112, the pneumatic valves 116 configured for selective activation by the computer 118. Air suspensions 112 may have one end mounted on axle 102 and the other end attached to the heavy vehicle at the chassis 122 or otherwise as is known to those skilled in the art.

Each air suspension 112 may include an airspring according to a further embodiment of the present invention. It will be appreciated that where each air suspension 112 is an airspring, each may be considered a pneumatic spring configured as a column of gas (air) confined within a container. The pressure of the confined gas, and not the structure of the container, acts as the force medium of the spring. A wide variety of sizes and configurations of airsprings are available, including sleeve-type airsprings, bellows-type airsprings, convoluted-type airsprings, rolling lobe airsprings, etc. Such airsprings commonly are used in both vehicular and industrial applications. Airsprings, regardless of their size and configuration, share many common elements. In general, an airspring includes a flexible, sleeve-like member made of fabric-reinforced rubber that defines the sidewall of an inflatable container. Each end of the flexible member is closed by an enclosure element, such as a bead plate which is attached to the flexible member by crimping. The uppermost enclosure element typically also includes air supply components and mounting elements, e.g., studs, blind nuts, brackets, pins, etc., to couple the airspring to the vehicle structure. The lowermost enclosure element also typically includes mounting elements to couple the airspring to the vehicle axle. Examples of airsprings are set forth and discussed in U.S. Pat. No. 6,957,806, the disclosure of which is incorporated by reference herein.

Each air suspension 112 may include a fitting (not shown) to which an air hose (also not shown) as well as a pneumatic valve 116 functionally attached. These structures may be used to inflate each air suspensions 112. In some embodiments, a pressure gauge (not shown) may be attached to the air hose line, allowing the pressure in the air suspension 112 and air hose to be monitored. Pneumatic valve 116 may include an exhaust, or a separate exhaust may be included for deflation of the air suspension 112.

The air hose may be attached to a gas source (not shown), such as an air compressor or a tank holding compressed air. The air compressor may be located on the prime mover of the heavy vehicle. Connection to the air compressor may be made through airlines also providing air to air brakes of the heavy vehicle (which may be through a system including a compressed air reservoir tank).

System 100 may further include a computer 118 for sensing a power-hop condition and selectively activating the air suspensions 112 to counteract the sensed power-hop condition. According to an embodiment of system 100 of the present invention, selective activation may include selectively increasing or decreasing air pressure in each air suspension 112, independently. According to an alternative embodiment of system 100, selective activation may include selectively increasing or decreasing air pressure in both air suspensions 112, identically.

System 100 may further include sensors 120A-F selectively mounted to the heavy vehicle and in communication with the computer 118 for sensing parameters useful for determining a power-hop condition. Such parameters may include, but are not limited to: vehicle acceleration, vehicle deceleration, engine speed, gear selection, hub rotation, driveline inclination, harmonic oscillation, axle vertical movement, axle load and axle torque.

Sensors 120A-F may include a chassis sensor 120A selectively mounted to chassis 122 (shown in dashed line) for measuring harmonic oscillation or vehicle acceleration/deceleration parameters, a wheel sensor(s) 120B selectively mounted to one or more wheels 110 for measuring hub rotation, an axle sensor 120C selectively mounted to the axle 102 for potentially measuring axle torque, axle load and axle vertical movement parameters, an engine speed sensor 120D mounted near or on a drive line 124 or other mechanical member emanating from the engine 108 for measuring engine speed (driveline rotation), a transmission sensor 120E within or disposed near the transmission 106 (or gear box/selector not shown in FIG. 1) for sensing gear selection parameter and engine sensor 120F within or disposed near the engine 108 for sensing engine speed, engine acceleration and any other useful parameter for calculating power-hop. Outputs from sensors 120A-F may be input to computer 118 for sensing of power-hop condition. While five sensors 120A-F are shown in FIG. 1, not all five sensors 120A-F may be required to sense a power-hop condition.

Sensing a power-hop condition may be achieved using the parameters such as those listed above in many different ways as known to those skilled in the art. For example and not by way of limitation, U.S. Pat. No. 6,401,853 to Turski et al. discloses sensing of a power-hop condition using engine speed, vehicle speed, and wheel speed sensors. U.S. Pat. No. 6,589,135 to Miller discloses sensing of a power-hop condition using an accelerometer. U.S. Pat. No. 5,474,147 to Yesel et al. discloses sensing of a power-hop condition using cyclical pressure fluctuations in the wheel motors of an all-wheel-drive vehicle, i.e., certain minimum pressure differentials over a given frequency range.

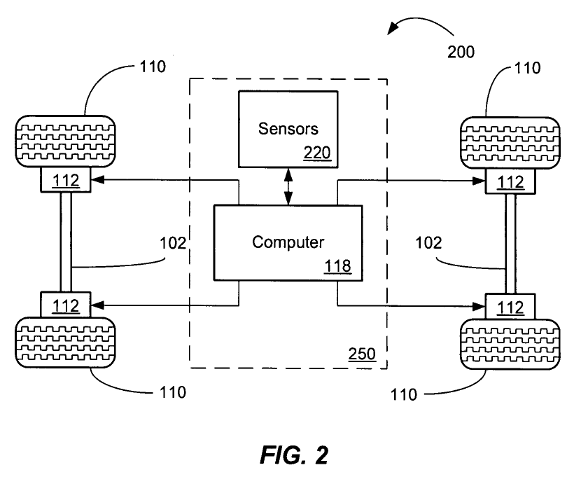

FIG. 2 is a block diagram of a two-axle air suspension system 200 for controlling power-hop according to the present invention. System 200 may include two axles 202 and air suspensions 112 in communication with computer 118. As in the single axle system 100, the air suspensions 112 according to the embodiment illustrated in FIG. 2 may be disposed along the axles at the opposite ends. The opposite ends may comprise hubs and/or wheels 110. System 200 may further include sensors 220 for sensing parameters indicative of a power-hop condition and feeding such measured parameters to computer 118. Sensors 220 may include one or more of sensors 120A-F as described above.

Air suspension systems 100 and 200 may be used on any sort of heavy vehicle. For example and not by way of limitation, the heavy vehicle may be an earth-moving apparatus. Representative examples of an earth moving apparatus which may be used in conjunction with the air suspension systems 100 and 200 of the present invention include, without limitation, the scrapers disclosed in U.S. Pat. Nos. 4,383,380, 4,388,769, 4,398,363, 4,553,608 and 6,347,670 all to Miskin.

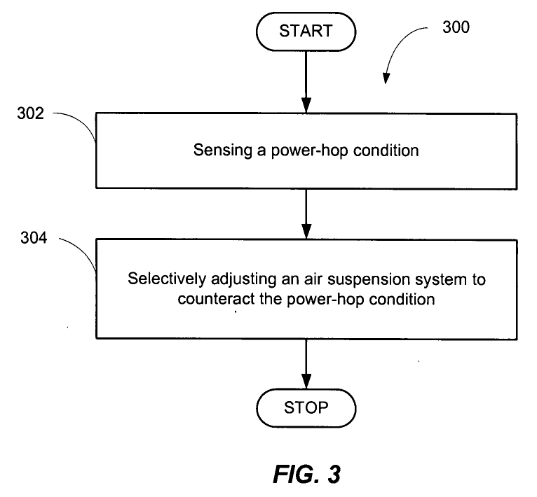

FIG. 3 is a flow chart of an embodiment of a method 300 of counteracting power-hop according to the present invention. Method 300 may include sensing 302 a power-hop condition and selectively adjusting 304 an air suspension system to counteract the power-hop condition. Sensing 302 the power-hop condition may include sensing a cyclical bounce at an axle comprising the air suspension system according to one embodiment of method 300. Sensing 302 the power-hop condition may include sensing vehicle acceleration or deceleration according to another embodiment of method 300. Sensing 302 the power-hop condition may include-sensing changes in vehicle speed according to yet another embodiment of method 300. Sensing 302 the power-hop condition may include sensing changes in pulling force according to still another embodiment of method 300. Of course, it will be readily apparent that sensing 302 may be for any of the parameters, individually or in combination as discussed above with regard to system embodiments 100 and 200. Selectively adjusting 304 an air suspension system may include selectively driving at least one pneumatic valve to increase or decrease air pressure within the air suspension system according to one embodiment of method 300.

Referring again to FIG. 2, a system 250 (shown in dashed line) for sensing and controlling power-hop in an active air suspension system is disclosed. System 250 may include a plurality of sensors 220 for measuring parameters relevant to a power-hop condition. System 250 may further include a computer 118 in communication with the plurality of sensors 220 and the active air suspension system 112. According to the embodiment of system 250, the computer 118 may be configured to selectively activate the active air suspension system 112 to minimize power-hop oscillations based on measured parameters received from the plurality of sensors 220. As noted above, such parameters may include, without limitation: vehicle acceleration, vehicle deceleration, engine speed, gear selection, hub rotation, driveline inclination, harmonic oscillation, axle vertical movement, axle load or axle torque.

Selectively activating the active air suspension may include selectively increasing or decreasing air pressure in the active air suspension according to system 250. The active air suspension may be configured to support a heavy vehicle on single axle or on two axles according to embodiments of system 250.

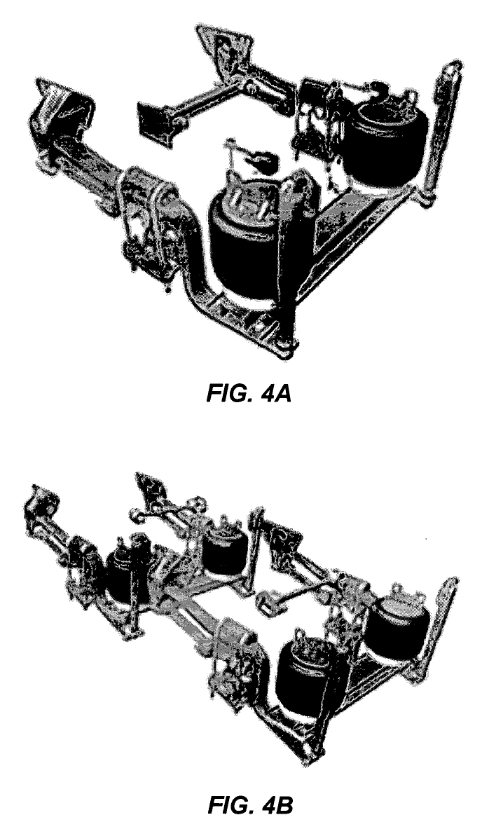

FIGS. 4A-B are images of exemplary conventional air suspension systems that provide the general structure for application of the systems 100, 200 and 250 according to the present invention. More particularly, FIG. 4A is a perspective view of a HAS™ Series Single-Axle Air Suspension available from Hendrickson USA, LLC. FIG. 4B is a perspective view of a HAS™ Series Tandem-Axle Air Suspension also available from Hendrickson USA, LLC. Of course, it will be readily apparent that the method and systems disclosed herein may be applied to any number of axles in any sort of heavy vehicle, not just those described herein.

While this invention has been described in certain illustrative embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An air suspension system for controlling power-hop on a heavy vehicle, comprising:
an axle having opposite ends;
air suspensions disposed along the axle, proximate the ends; and
a computer for sensing a power-hop condition and selectively activating the air suspensions to counteract the sensed power-hop condition.

2. The system according to claim 1, further comprising pneumatic valves in communication with the air suspensions, the pneumatic valves configured for selective activation by the computer.

3. The system according to claim 2, wherein selective activation comprises selectively increasing or decreasing air pressure in each air suspension independently.

4. The system according to claim 2, wherein selective activation comprises selectively increasing or decreasing air pressure in both air suspensions identically.

5. The system according to claim 1, further comprising sensors selectively mounted to the heavy vehicle and in communication with the computer for sensing at least one of: vehicle acceleration, vehicle deceleration, engine speed, gear selection, hub rotation, driveline inclination, harmonic oscillation, axle vertical movement, axle load or axle torque.

6. The system according to claim 1, further comprising:
a second axle; and
air suspensions in communication with the computer and disposed along opposite ends of the second axle.

7. The system according to claim 1, wherein the axle comprises a front axle.

8. The system according to claim 1, wherein the axle comprises a rear axle.

9. The system according to claim 1, wherein the axle further comprises wheels disposed axially about opposite ends of the axle.

10. The system according to claim 1, wherein the heavy vehicle comprises an earth-moving apparatus.

11. A method of counteracting power-hop, comprising:
sensing a power-hop condition; and
selectively adjusting an air suspension system to counteract the power-hop condition.

12. The method according to claim 11, wherein sensing the power-hop condition comprises sensing a cyclical bounce at an axle comprising the air suspension system.

13. The method according to claim 11, wherein sensing the power-hop condition comprises sensing vehicle acceleration or deceleration.

14. The method according to claim 11, wherein sensing the power-hop condition comprises sensing changes in vehicle speed.

15. The method according to claim 11, wherein sensing the power-hop condition comprises sensing changes in pulling force.

16. The method according to claim 11, wherein selectively adjusting an air suspension system comprises selectively driving at least one pneumatic valve to increase or decrease air pressure within the air suspension system.

17. A system for sensing and controlling power-hop in an active air suspension system, comprising:
a plurality of sensors for measuring parameters relevant to a power-hop condition;
a computer in communication with the plurality of sensors and the active air suspension system, the computer configured to selectively activate the active air suspension system to minimize power-hop oscillations based on the measured parameters received from the plurality of sensors.

18. The system according to claim 17, wherein each of the plurality of sensors is configured to measure at least one of the following parameters: vehicle acceleration, vehicle deceleration, engine speed, gear selection, hub rotation, driveline inclination, harmonic oscillation, axle vertical movement, axle load or axle torque.

19. The system according to claim 17, wherein selectively activating the active air suspension comprises selectively increasing or decreasing air pressure in the active air suspension.

20. The system according to claim 17, wherein the active air suspension supports a heavy vehicle on single axle.

21. The system according to claim 17, wherein the active air suspension supports a heavy vehicle on two axles.
